(19) United States
(12) Patent Application Publication
(10) Pub. No.: US 2026/0212070 A1
(43) Pub. Date: Jul. 23, 2026

(54) CRYSTAL DEFECT PREDICTION DEVICE, CRYSTAL DEFECT PREDICTION METHOD, AND CRYSTAL DEFECT PREDICTION PROGRAM

(71) Applicant: Kioxia Corporation, Tokyo (JP)

(72) Inventor: Jumpei INOUE, Hiratsuka Kanagawa (JP)

(21) Appl. No.: 19/332,661

(22) Filed: Sep. 18, 2025

(30) Foreign Application Priority Data
Jan. 23, 2025 (JP) 2025-010129

(51) Int. Cl. G06F 30/20; G06F 111/10

(52) U.S. Cl. CPC G06F 30/20; G06F 2111/10

(57) ABSTRACT

A crystal defect prediction method includes storing, in a memory device, computer code that implements a formula for estimating a stress generated in an overlapping portion between first and second layers in a semiconductor device, the formula being derived from a differential equation that governs displacements generated in the first layer and including variables for dimensions of the first and second layers, dimensions of the overlapping portion, and a correction factor. The method further includes: setting the value of the correction factor; executing the computer code in a processor, after setting the value of the correction factor and after substituting actual dimensions of the first and second layers, and actual dimensions of the overlapping portion for the respective variables in the formula, to estimate the stress in the overlapping portion; and determining a risk of the crystal defect based on the estimated stress in the overlapping portion.

### CROSS-REFERENCE TO RELATED APPLICATION(S)

This application is based upon and claims the benefit of priority from Japanese Patent Application No. 2025-010129, filed Jan. 23, 2025, the entire contents of which are incorporated herein by reference.

### FIELD

Embodiments described herein relate generally to a crystal defect prediction device, a crystal defect prediction method, and a crystal defect prediction program.

### BACKGROUND

Before manufacturing a semiconductor device, the stress generated in the semiconductor device may be calculated by simulation to predict a location where a crystal defect could occur in the semiconductor device. However, a problem is that a simulation for calculating the stress has a high calculation cost.

### BRIEF DESCRIPTION OF THE DRAWINGS

FIG. 1 is a cross-sectional view showing a structure of a semiconductor device according to a first embodiment.

FIG. 2 is a plan view showing a structure of the semiconductor device according to the first embodiment.

FIG. 3 is a cross-sectional view showing a substrate and a gate conductive film of the semiconductor device according to the first embodiment.

FIG. 4 is a diagram showing a structure of a mathematical model according to the first embodiment.

FIG. 5 is a view illustrating an even extension of the mathematical model according to the first embodiment.

FIG. 6 is a flowchart showing a flow of a crystal defect prediction method according to the first embodiment.

FIG. 7 is a graph showing a result of the crystal defect prediction method according to the first embodiment.

FIG. 8 is another graph showing the result of the crystal defect prediction method according to the first embodiment.

FIG. 9 is a block diagram showing a device configuration of a crystal defect prediction device according to a second embodiment.

FIG. 10 is a block diagram showing a functional configuration of the crystal defect prediction device according to a second embodiment.

### DETAILED DESCRIPTION

Embodiments provide a crystal defect prediction device, a crystal defect prediction method, and a crystal defect prediction program that make it easy to calculate a stress and predict a crystal defect.

In general, according to one embodiment, a crystal defect prediction method includes storing, in a memory device of an information processing device, computer code that implements a formula for estimating a stress generated in an overlapping portion that is between a first layer and a second layer in a semiconductor device, the formula being derived from a differential equation that governs displacements generated in the first layer and including variables for dimensions of the first layer, dimensions of the second layer, dimensions of the overlapping portion, and a correction factor which is set based on experimental data. The method further includes: setting the value of the correction factor so that a difference between the stress estimated for a sample by the formula and the stress from the experimental data generated for the sample, is within a threshold; executing the computer code that implements the formula in a processor of the information processing device, after setting the value of the correction factor and after substituting actual dimensions of the first layer, actual dimensions of the second layer, and actual dimensions of the overlapping portion for the respective variables in the formula, to estimate the stress in the overlapping portion; and determining a risk of the crystal defect in the semiconductor device based on the estimated stress in the overlapping portion.

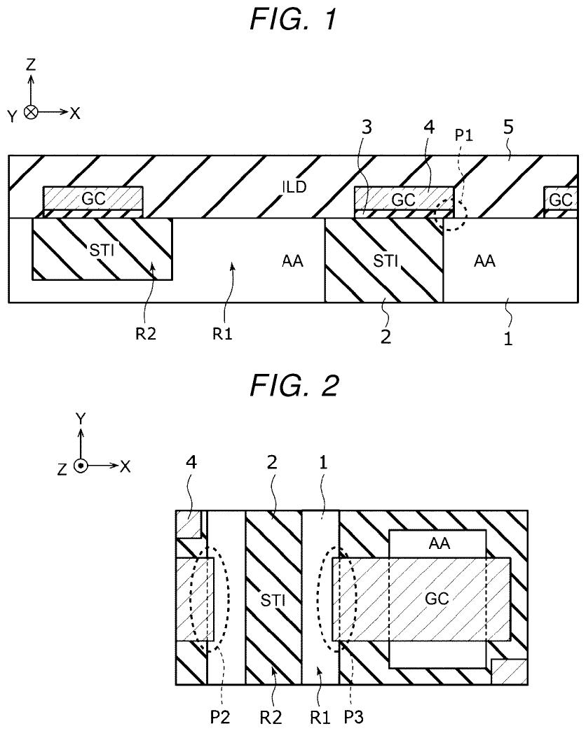

Hereinafter, embodiments of the present disclosure will be described with reference to the drawings. In FIGS. 1 to 10, the same components are denoted by the same reference symbols, and redundant description will be avoided.

### First Embodiment

FIG. 1 is a cross-sectional view showing a structure of a semiconductor device according to a first embodiment.

The semiconductor device of the present embodiment includes a substrate 1, a device isolation insulating film 2, a gate insulating film 3, a gate conductive film (GC: Gate Conductor) 4, and an interlayer insulating film (ILD: Inter Layer Dielectric) 5. The substrate 1 is an example of a first layer, and the gate conductive film 4 is an example of a second layer. The semiconductor device of the present embodiment includes a plurality of transistors formed by the substrate 1, the gate insulating film 3, the gate conductive film 4, and the like.

The substrate 1 is, for example, a semiconductor substrate such as a silicon (Si) substrate. FIG. 1 shows X and Y directions parallel to a surface of the substrate 1 and perpendicular to each other, and a Z direction perpendicular to the surface of the substrate 1. In the present specification, a +Z direction is treated as an upward direction, and a-Z direction is treated as a downward direction. The −Z direction may or may not coincide with a gravity direction.

The device isolation insulating film 2 is embedded in a device isolation groove formed in the substrate 1. The device isolation insulating film 2 is, for example, a silicon oxide (SiO₂) film such as a non-doped silicate glass (NSG) film.

The semiconductor device of the present embodiment further includes a plurality of device regions R1 in the substrate 1 and a plurality of device isolation regions R2 in the device isolation insulating film 2. Each device isolation region R2 is a part of the region in the device isolation insulating film 2. The device isolation region R2 is also called a shallow trench isolation (STI). Meanwhile, each device region R1 is a part of the region in the substrate 1 and is interposed between the device isolation regions R2 adjacent to each other. The device region R1 is also called an active area (AA).

The gate insulating film 3 and the gate conductive film 4 are sequentially formed on the substrate 1 (device region R1) and the device isolation insulating film 2 (device isolation region R2). The gate insulating film 3 is, for example, a SiO₂ film. The gate conductive film 4 is, for example, a polysilicon layer. Each of the transistors of the present embodiment includes a part of the gate insulating film 3 and a part of the gate conductive film 4, and the part of the gate conductive film 4 corresponds to the gate electrode of each transistor. The gate insulating film 3 may be a film other than the SiO₂ film, and may be, for example, a high-k insulating film. In addition, the gate conductive film 4 may be a layer other than the polysilicon layer, and may be, for example, a metal layer or a metal silicide layer.

The interlayer insulating film 5 is formed on the substrate 1, the device isolation insulating film 2, the gate insulating film 3, and the gate conductive film 4. The interlayer insulating film 5 is, for example, a SiO₂ film.

FIG. 1 further shows an overlapping portion P1 between the substrate 1 (device region R1) and the gate conductive film 4. In the overlapping portion P1, the gate conductive film 4 is located in the +Z direction of the device region R1 and overlaps the device region R1 in plan view. When the gate insulating film 3 and the gate conductive film 4 are formed on the substrate 1 and the device isolation insulating film 2, a stress is applied to the overlapping portion P1 and the like in the semiconductor device of the present embodiment.

In the overlapping portion P1, the side surface of the gate conductive film 4 is located in the vicinity of the interface between the device region R1 and the device isolation region R2. In this case, there is a high possibility that a large stress is generated in the overlapping portion P1, and as a result, there is a high possibility that a crystal defect occurs in the overlapping portion P1 or the vicinity thereof.

FIG. 2 is a plan view showing a structure of the semiconductor device according to the first embodiment.

FIG. 2 shows an example of a layout of the plurality of device regions R1 in the substrate 1, the plurality of device isolation regions R2 in the device isolation insulating film 2, and the gate conductive film 4 on the substrate 1 and the device isolation insulating film 2. In the overlapping portion P2 shown in FIG. 2, the side surface of the gate conductive film 4 is located in the vicinity of the interface between the device region R1 and the device isolation region R2. Therefore, there is a high possibility that a large stress is generated in the overlapping portion P2, and as a result, there is a high possibility that a crystal defect occurs in the overlapping portion P2 or the vicinity thereof. The same applies to the overlapping portion P3 shown in FIG. 2.

In the semiconductor device of the present embodiment, a stress is applied to an overlapping portion of two materials of different types, and the like. For example, a stress is applied to overlapping portions P1 to P3 between the substrate 1 (for example, a single crystal Si layer) and the gate conductive film 4 (for example, a polycrystalline Si layer, a metal layer, a metal silicide layer, and the like). Hereinafter, a method of calculating such stress before manufacturing the semiconductor device of the present embodiment will be described with reference to FIGS. 3 to 8. In the present embodiment, a location where a crystal defect occurs in the semiconductor device of the present embodiment is predicted based on a result of stress calculation.

FIG. 3 is a cross-sectional view showing the substrate 1 (device region R1) and the gate conductive film 4 of the semiconductor device according to the first embodiment.

FIG. 3 shows a vertical cross-section (XZ cross section) of the device region R1 and the gate conductive film 4 forming the overlapping portion P1 described above. In FIG. 3, the shape of the device region R1 and the gate conductive film 4 in the vertical cross-section is a rectangle. FIG. 3 further shows various dimensions of the device region R1, the gate conductive film 4, and the overlapping portion P1, specifically, a length a of the side of the rectangle in the X direction representing the shape of the device region R1, a length b of the side of the rectangle in the Z direction representing the shape of the device region R1, a length L of the side of the rectangle in the X direction representing the shape of the gate conductive film 4, and a length l of the overlapping portion P1 in the X direction. The length b corresponds to the thickness of the device region R1, and the length L corresponds to the width of the gate conductive film 4. The side of the length a, the side of the length b, and the side of the length L are examples of a first side, a second side, and a third side, respectively. FIG. 3 does not show the gate insulating film 3 between the device region R1 and the gate conductive film 4.

In the present embodiment, a formula representing the stress generated in the overlapping portion P1 is derived in a form including the lengths a, b, L, and 1 as variables. The values of the lengths a, b, L, and I are substituted into the formula, that is, the values of the lengths a, b, L, and I are substituted into the variables representing the lengths a, b, L, and 1, thereby calculating the value of the stress. Hereinafter, in order to distinguish between the variables representing the lengths a, b, L, and l and the values of the lengths a, b, L, and 1, the variables representing the lengths a, b, L, and l are also referred to as “parameters a, b, L, and 1”, and the values of the lengths a, b, L, and I are also referred to as “parameter a, b, L, and l values”.

In the present embodiment, it is assumed that the thickness of the substrate 1 is sufficiently greater than the thickness of the gate conductive film 4, that is, the length of the side of the rectangle in the Z direction representing the shape of the gate conductive film 4. In this case, it is assumed that the influence of the thickness of the gate conductive film 4 on the stress is sufficiently small. Therefore, in the present embodiment, the formula representing the stress generated in the overlapping portion P1 is derived in a form that does not include the thickness of the gate conductive film 4 as a variable.

In addition, in the present embodiment, it is assumed that the thickness of the gate insulating film 3 is sufficiently smaller than the thickness of the gate conductive film 4. In this case, it is assumed that the influence of the gate insulating film 3 on the stress is sufficiently small. In addition, silicon oxide, which is the material of the gate insulating film 3, is less susceptible to thermal expansion and contraction that cause a stress, compared to silicon, which is the material of the substrate 1 and the gate conductive film 4. The same applies when the material of the gate insulating film 3 is a high-k insulator or when the material of the gate conductive film 4 is a metal or a metal silicide. Therefore, in the present embodiment, the formula representing the stress generated in the overlapping portion P1 is derived in a form in which the dimensions of the gate insulating film 3 are not included as variables.

The values of the parameters a, b, L, and I are extracted from the design data of the semiconductor device of the present embodiment, for example. For example, a plurality of overlapping portions (for example, overlapping portions P1 to P3) are extracted from design data showing a layout of the plurality of device regions R1 and the gate conductive film 4 in a plan view, and the values of the parameters a, b, L, and I are extracted from the design data for each of the overlapping portions. In this case, the overlapping portion to be extracted may be limited to an overlapping portion having a rectangular shape in a plan view.

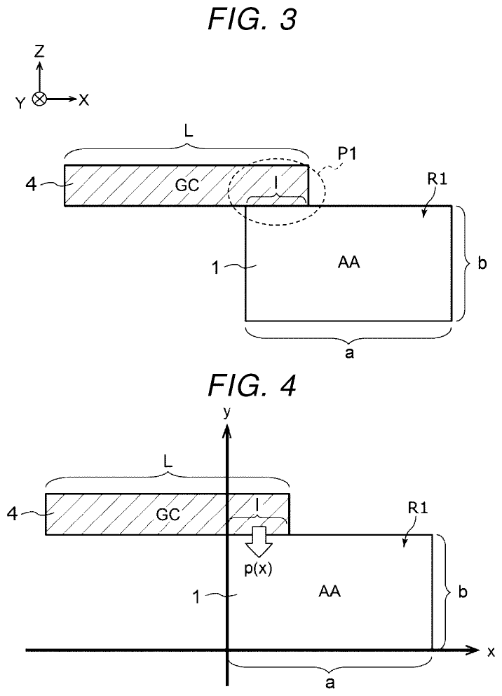

FIG. 4 is a diagram showing a structure of a mathematical model of the first embodiment.

FIG. 4 shows a mathematical model corresponding to the vertical cross-section of the device region R1, the gate conductive film 4, and the overlapping portion P1 shown in FIG. 3. The x direction shown in FIG. 4 corresponds to the above-described X direction, and the y direction shown in FIG. 4 corresponds to the above-described Z direction. Therefore, the parameter a represents a length of the device region R1 in the x direction, the parameter b represents a length of the device region R1 in the y direction, the parameter L represents a length of the gate conductive film 4 in the x direction, and the parameter I represents a length of the overlapping portion P1 in the x direction. In FIG. 4, the lower left corner portion of the device region R1 is located at the origin of the xy coordinate system. In the present embodiment, a mathematical model shown in FIG. 4 is used to derive a formula representing the stress generated in the overlapping portion P1.

As described above, since the influence of the gate insulating film 3 on the stress can be ignored, the mathematical model shown in FIG. 4 does not include the gate insulating film 3. Therefore, in the mathematical model shown in FIG. 4, the upper surface of the device region R1 and the lower surface of the gate conductive film 4 overlap and are in contact with each other in the overlapping portion P1, and the overlapping portion P1 is an interface between the device region R1 and the gate conductive film 4.

In the present embodiment, since the stress of the device region R1 in the vertical cross-section is considered because the device region R1 is an elastic body, it is assumed that the device region R1 is in a state of planar distortion. Therefore, a displacement u generated in the device region R1 shown in FIG. 4 is given by the following equation (1).

Δu+(1/(1−2 v))∇(∇·u)=0 in Q⊂R² Equation 1:

Equation (1) is a differential equation satisfied by the displacement u, and more specifically, is a partial differential equation including x and y as variables. The displacement u in Equation (1) is a displacement vector represented by a displacement uₓ in the x direction generated at a point (x, y) in the device region R1 and a displacement u_{y} in the y direction generated at the point (x, y) in the device region R1. The displacement uₓ corresponds to an x component of the displacement u, and the displacement u_{y} corresponds to a y component of the displacement u. In Equation (1), v represents a Poisson's ratio, and Ω represents a region occupied by a vertical cross-section of the device region R1 shown in FIG. 4.

In the present embodiment, it is assumed that the device region R1 is in a state of planar distortion, and thus, Equation (1) does not include z as a variable, and the displacement u in Equation (1) does not include a z component (displacement u_{z} in the z direction). When the z direction is indicated in FIG. 4, the z direction corresponds to the above-described Y direction.

FIG. 4 further shows a pressure p(x) received by the device region R1 from the gate conductive film 4. In the present embodiment, the pressure p(x) is used as a boundary condition for solving the partial differential equation of Equation (1). It is considered that the device region R1 shown in FIG. 4 receives a force from the gate conductive film 4 at the overlapping portion P1 between the device region R1 and the gate conductive film 4, but does not receive a force from the gate conductive film 4 at other portions. Therefore, the pressure p(x) is given by the following equation (2).

p(x):={L/(l^{γ}) for 0<x<l, 0 otherwise Equation 2:

The pressure p(x) in Equation (2) represents a downward force per unit length in the x direction received from the gate conductive film 4 at the point (x, b) in the device region R1. A point (x, b) is located on the upper surface of the device region R1 in the range of 0<x<a and is located in the overlapping portion P1 in the range of 0<x<1. Since the device region R1 receives a force from the gate conductive film 4 at the overlapping portion P1, but does not receive a force from the gate conductive film 4 at other portions, the pressure p(x) is a value other than 0 in the range of 0<x<1 (in the overlapping portion P1), and is 0 in other ranges (outside the overlapping portion P1).

In the range of 0<x<l, the pressure p(x) is L/l^{γ}. The numerator of the pressure p(x) is the length L of the gate conductive film 4 in the X direction, and the denominator of the pressure p(x) is the γ power of the length l of the overlapping portion P1 in the X direction. Here, γ is a real number greater than 0 and less than 1 (0<γ<1). Hereinafter, γ is referred to as a “parameter γ”, and a value of γ is referred to as a “value of the parameter γ”.

When the value of the parameter γ is 1, the pressure p(x) becomes an approximation series of a delta function. In the present embodiment, since the value of the parameter γ is greater than 0 and less than 1, the pressure p(x) is a function having a maximum value smaller than a maximum value of an approximation series of the delta function. Therefore, the pressure p(x) according to the present embodiment is referred to as a “weak delta approximation series”. The weak delta approximation series is a function in which the pressure p(x) received by the device region R1 from the gate conductive film 4 is localized to the overlapping portion P1, and thus, the pressure p(x) has a value other than 0 in the overlapping portion P1 and is 0 in the other portions.

In the present embodiment, as will be described later, a formula representing the stress generated in the overlapping portion P1 is derived by solving the partial differential equation of Equation (1) using the boundary condition of Equation (2). The value of the stress may be calculated by substituting predetermined values into the parameters a, b, L, l, and γ in the formula, or may be calculated by substituting predetermined values into the parameters a, b, L, and l in the formula and adjusting the value of the parameter γ in the formula. In the former case, for example, 0.5 may be substituted into the parameter γ. The reason is that 0.5 or a value close to 0.5 is an experimentally appropriate value of the parameter γ. Meanwhile, details of the latter case will be described below.

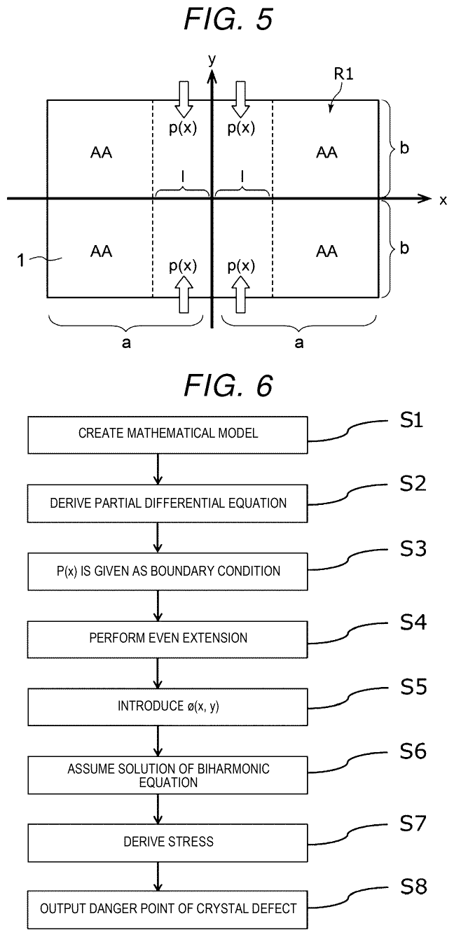

FIG. 5 is a view illustrating an even extension of the mathematical model according to the first embodiment.

In the present embodiment, the partial differential equation of Equation (1) is not numerically solved by using a numerical solution, but is analytically solved by using an even extension. As a result, it is possible to avoid a problem that it takes a long time to numerically solve the partial differential equation of Equation (1).

FIG. 4 shows a region Q of the device region R1 before an even extension, and FIG. 5 shows the region Q of the device region R1 after an even extension. The region Q before an even extension is a rectangle surrounded by points (0, 0), (a, 0), (a, b), and (0, b), and has an area of a×b (see FIG. 4). Meanwhile, the region Q after an even extension is a rectangle surrounded by points (−a,−b), (a, b), (a, b), and (−a, b), and has an area of 2a×2b (see FIG. 5). In FIG. 5, an even extension is also applied to the pressure p(x) that the device region R1 receives from the gate conductive film 4.

In the present embodiment, a formula representing the stress is derived by solving the partial differential equation of Equation (1) using the boundary condition of Equation (2), and obtaining the stress from the solution of the partial differential equation. In this process, the solution of the partial differential equation for the region Ω in FIG. 5 can be obtained by solving the partial differential equation using an even extension. Thereafter, by extracting only the solution of the region Ω in FIG. 4 from the solution for the region Ω in FIG. 5, the solution of the partial differential equation for the mathematical model of FIG. 4 can be obtained. In the present embodiment, the formula representing the stress is derived by obtaining the stress from the solution for the region Ω in FIG. 4.

In the present embodiment, a potential function φ of the stress is used to solve the partial differential equation of Equation (1). The potential function φ is given by the following Equation (3).

σₓₓ=∂²φ/∂y², σ_{yy}=∂²φ/∂x²,σ_{xy}=−∂²φ/∂x∂y Equation 3:

In Equation (3), σₓₓ, σ_{yy}, and σ_{xy} respectively indicate an xx component, a yy component, and an xy component of a stress tensor σ, which is a tensor representing the stress in the device region R1. Further, the potential function φ of Equation (3) is called an Airy stress function. The stress tensor σ at a point (x, y) is represented by “σ(x, y)”, and the potential function φ at the point (x, y) is represented by “φ(x, y)”.

Here, by applying the potential function φ of Equation (3), the distortion-displacement relational expression of Equation (4), and the distortion-stress relational expression of Equation (5) to Equation (1), Equation (1) is transformed into Equation (6).

εₓₓ=∂u/∂x,ε_{yy}=∂v/∂y,ε_{xy}=(½)*(∂u/∂y+∂v/∂x) Equation 4:

2μεₓₓ=(1−v)σₓₓ−vσ_{yy},2με_{yy}=(1−v)σ_{yy}−vσₓₓ,2με_{xy}=σ_{xy} Equation 5:

Δ²φ=0 in Ω Equation 6:

In Equation (4), u corresponds to the above-mentioned uₓ, and v corresponds to the above-mentioned u_{y}. Further, εₓₓ, ε_{yy}, and ε_{xy} respectively indicate an xx component, a yy component, and an xy component of a strain tensor ε, which is a tensor representing the strain in the device region R1. The strain tensor ε at the point (x, y) is represented by “ε(x, y)”. In addition, in Equation (5), μ represents a shear modulus. Further, Equation (6) is called a biharmonic equation.

It can be assumed that the solution of the biharmonic equation of Equation (6) can be represented by a series expansion of a variable separation type from the symmetry of the region 22 in FIG. 5. For example, it can be assumed that the solution of the biharmonic equation of Equation (6) is given by the following Equation (7).

φ(x,y):=Σ[n=1 to ∞][Cₙ cos(βₙx)*[−(1+(βₙb/tan h(βₙb)))cos h(βₙy)+βₙy sin h(βₙy)]]+Σ[m=1 to ∞][Gₘ cos(αₘy)*[−(1+(αₘa/tan h(αₘa)))cos h(αₘx)+αₘx sin h(αₘx)]+C₀x²] Equation 7:

However, αₘ and βₙ are given by the following Equation (8).

αₘ:=mπ/b,βn:=nπ/a(m,n∈N) Equation 8:

Equation (7), which is a solution of the biharmonic equation of Equation (6), includes unknown variables Cₙ and Gₘ. In the present embodiment, the variables Cₙ and Gₘ are determined by using the boundary condition of Equation (2). Thereby, a variable C₀ is given by Equation (9). Further, by solving the simultaneous equations of Equation (11) using Equation (10), the variable Cₙ other than the variable C₀ is also given. Further, the variable Gₘ is given by Equation (12).

C₀:=−(Ll^{1-γ})/2a Equation 9:

Rₘₙ:=[4(−1)^{m+n}βₙ³ sin h(αₘa)sin h(βₙb)]/[b(αₘ²+βₙ²)²(αₘa+sin h(αₘa)cos h(αₘa))](m,n∈N)Sₙₘ:=[4(−1)^{m+n}αₘ³ sin h(αₘa)sin h(βₙb)]/[a(αₘ²+βₙ²)²(βₙb+sin h(βₙb)cos h(βₙb))](m,n∈N)T_{n:=-[}2L sin h(βₙb)sin(βₙl)]/[αβₙ³lγ(βₙb+sin h(βₙb)cos h(βₙb))](n∈N) Equation 10:

Σ[k=1 to ∞](δₙₖ−Σ[m=1 ∞]SₙₘRₘₖ)Cₖ=Tₙ(n∈N) Equation 11:

Gₘ:=Σ[n=1 to ∞]RₘₙCₙ(m∈N) Equation 12:

Equations (8) to (12) include the above-described parameters a, b, L, l, and γ. Therefore, by applying Equations (8) to (12) to Equation (7), the potential function φ, which is a solution of the biharmonic equation, is derived in a form including the parameters a, b, L, l, and γ.

In the mathematical model shown in FIG. 4, a large stress is likely to be applied to the overlapping portion P1 between the device region R1 and the gate conductive film 4. The stress applied to the overlapping portion P1 is derived from the potential function φ, which is a solution of the biharmonic equation, by using the equation (3) to obtain the stress components σₓₓ, σ_{yy}, and σ_{xy}, and is given by substituting y=b into the stress components σₓₓ, σ_{yy}, and σ_{xy}. In other words, the stress applied to the overlapping portion P1 is given by the stress components σₓₓ(x, b), σ_{yy}(x, b), and σ_{xy}(x, b) as in Equation (13).

σₓₓ(x,b)=Σ[n=1 to ∞]βₙ²Cₙ cos(βₙx)*[−(1+(βₙb/tan h(βₙb)))cos h(βₙb)+βₙb sin h(βₙb)+2 cos h(βₙb)]−Σ[m=1 to ∞]αₘ²Gₘ cos(αₘb)*[−(1+(αₘa/tan h(αₘa)))cos h(αₘx)+aₘx sin h(aₘx)]σ_{yy}(x,b)=−Σ[n=1 to ∞]βₙ²Cₙ cos(βₙx)*[−(1+(βₙb/tan h(βₙb)))cos h(βₙb)+βₙb sin h(βₙb)]+2C₀+Σ[m=1 to ∞]αₘ²Gₘ cos(αₘb)*[−(1+(αₘa/tan h(αₘa)))cos h(aₘx)+aₘx sin h(aₘx)+2 cos h(aₘx)]σ_{xy}(x,b)=Σ[n=1 to ∞]βₙ²Cₙ sin(βₙx)*[−(1+(βₙb/tan h(βₙb)))sin h(βₙb)+βₙb cos h(βₙb)+sin h(βₙb)]+Σ[m=1 to ∞]αₘ²Gₘ sin(αₘb)*[−(1+(αₘa/tan h(αₘa)))sin h(aₘx)+αₘx cos h(aₘx)+sin h(aₘx)] Equation 13:

According to Equation (13), the stress generated in the overlapping portion P1 is given by the formula represented by the series expansion. The variables Cₙ and Gₘ in Equation (13) are represented by the parameters a, b, L, l, and y by applying Equations (8) to (12) to Equation (13). Thereby, the stress (stress components σₓₓ, σ_{yy}, and σ_{xy}) generated in the overlapping portion P1 are derived in a form including the parameters a, b, L, l, and γ.

The stress generated in the overlapping portion P1 can also be represented by a scalar quantity, which is a Mises stress σ_{Mises} derived from the stress components σₓₓ, σ_{yy}, and σ_{xy}. The Mises stress σ_{Mises} (x, b) generated in the overlapping portion P1 is given by Equation (14).

σ_{Mises}(x,b)=sqrt[σₓₓ(x,b)²−σₓₓ(x,b)σ_{yy}(x,b)+σ_{yy}(x,b)²+3σ_{xy}(x,b)²] Equation 14:

In the present embodiment, the values of the parameters a, b, L, l, and y are substituted into Equations (13) and (14) to calculate the values of the stress generated in the overlapping portion P1. For example, the values of the stress components σₓₓ, σ_{yy}, and σ_{xy} at the overlapping portion P1 are calculated from Equation (13), and the value of the Mises stress σ_{Mises} at the overlapping portion P1 is calculated from Equation (14). In the present embodiment, a location where a crystal defect occurs in the semiconductor device of the present embodiment is predicted based on a value of a calculated stress. In the present embodiment, with respect to these four values (values of σₓₓ, σ_{yy}, σ_{xy}, and σ_{Mises}), all of the four values may be calculated, or only a part of the four values may be calculated.

In calculating the stress from Equations (13) and (14), the value of the parameter γ may be set to, for example, 0.5 as described above. Meanwhile, the stress may be calculated by adjusting the value of the parameter γ in Equations (13) and (14). As a result, it is possible to calculate the stress while setting the value of the parameter γ to an appropriate value by adjusting the value of the parameter γ. For example, the value of the parameter γ may be adjusted such that the prediction result of a location where a crystal defect occurs is consistent with the experimental result of the location where the crystal defect occurs. The experimental result of the location where the crystal defect occurs can be obtained from, for example, a scanning electron microscope (SEM) image or a transmission electron microscope (TEM) image of a manufactured semiconductor device.

FIG. 6 is a flowchart showing a flow of a crystal defect prediction method according to the first embodiment. In the method shown in FIG. 6, the processing described with reference to FIGS. 4 and 5 is performed.

First, a mathematical model that can obtain the above parameters a, b, L, and 1 is created (step S1). An example of such a mathematical model is shown in FIG. 4. Hereinafter, a mathematical model including the device region R1, the gate conductive film 4, and the overlapping portion P1 will be described with reference to FIG. 6 as an example, but the following description is also applicable to other mathematical models including an overlapping portion of two materials of different types.

Next, it is assumed that the device region R1 is in a state of planar distortion, and a partial differential equation of Equation (1) is derived (step S2). Next, the pressure p(x) in Equation (2) is given as the boundary condition of the partial differential equation (step S3).

Next, the even extension of the region Ω of the device region R1 is performed (step S4). The region Ω of the device region R1 before an even extension is shown in FIG. 4, and the region Ω of the device region R1 after an even extension is shown in FIG. 5.

Next, the potential function φ of Equation (3) is introduced into the above partial differential equation (step S5). As a result, the above partial differential equation is transformed into the biharmonic equation of Equation (6).

Next, the solution of the biharmonic equation is assumed as in Equation (7) (step S6). As a result, it is possible to derive the potential function φ, which is a solution of the biharmonic equation, in a form including the parameters a, b, L, l, and γ.

Next, the stress generated in the overlapping portion P1 is derived from the potential function φ by using Equation (3) (step S7). For example, the stress components σₓₓ(x, b), σ_{yy} (x, b), and σ_{xy} (x, b) of Equation (13) and the Mises stress σ_{Mises}(x, b) of Equation (14) are derived.

In the present embodiment, Equations (13) and (14) are stored in the information processing device, and the values of the parameters a, b, L, l, and γ are substituted into Equations (13) and (14) in the information processing device. Thereby, the value of the stress generated in the overlapping portion P1 is calculated from Equations (13) and (14). For example, the values of the stress components σₓₓ(x, b), σ_{yy}(x, b), and σ_{xy}(x, b) are calculated from Equation (13), and the value of the Mises stress σ_{Mises}(x, b) is calculated from Equation (14). An example of such an information processing device is a crystal defect prediction device 10 of a second embodiment to be described below.

According to the present embodiment, by modeling the semiconductor device of the present embodiment (FIGS. 1 and 2) to the above mathematical model, the value of the stress generated in the semiconductor device of the present embodiment can be calculated from Equations (13) and (14). Specifically, the value of the stress generated in the overlapping portion P1 shown in FIG. 1 is calculated from Equations (13) and (14). Therefore, the information processing device generates information related to a crystal defect predicted to occur in the semiconductor device of the present embodiment, based on the value of the calculated stress, and outputs the generated information from the information processing device. For example, a prediction result of a location where a crystal defect occurs is displayed on a screen of the information processing device.

In the present embodiment, when the Mises stress σ_{Mises} at a certain point on the overlapping portion P1 is greater than a threshold, the point is determined to be a danger point at which a crystal defect is predicted to occur. The information processing device outputs a point at which the Mises stress σ_{Mises} is greater than a threshold as a danger point of a crystal defect (step S8). The information related to the danger point may be displayed in characters on the screen of the information processing device, or may be displayed in a figure or a table on the screen of the information processing device.

The above threshold may be a value that changes according to a value of the parameter γ. In this case, the value of the parameter γ can be adjusted to adjust the value of the threshold. For example, the value of the parameter γ may be adjusted to adjust the value of the threshold such that the prediction result of the location where a crystal defect occurs is consistent with the experimental result of the location where the crystal defect occurs. As a result, it is possible to set the threshold of the Mises stress σ_{Mises} to an appropriate value. As described above, the experimental result of the location where a crystal defect occurs can be obtained from, for example, an SEM image or a TEM image of a manufactured semiconductor device.

In addition, in step S8, Equations (13) and (14) stored in a recording medium of the information processing device may be preliminarily stored in the recording medium of the information processing device or may be preliminarily stored in another device. In the former case, the information processing device obtains the data of Equation (13) and Equation (14) from the recording medium before executing step S8. In the latter case, the information processing device obtains the data of Equation (13) and Equation (14) by network communication from another device before executing step S8.

The information related to a crystal defect may be output from the information processing device in a display form or may be output from the information processing device in another form. For example, the information related to a crystal defect described above may be output from the information processing device in a form stored in a storage medium of the information processing device, or may be output from the information processing device in a form transmitted to another device by network communication.

In addition, the information processing device may obtain values to be substituted for the parameters a, b, L, and 1 in step S8 by any method. For example, the information processing device may extract these values from the design data of the semiconductor device of the present embodiment as described above, and substitute the extracted values for the parameters a, b, L, and l. In this case, the value extracted from the design data may be preliminarily stored in the recording medium of the information processing device or may be preliminarily stored in another device. The processing of extracting these values from the design data may be performed by a device other than the information processing device or may be performed by a person. In addition, the values substituted for the parameters a, b, L, and 1 in step S8 may be input by a person to the information processing device. The same applies to the parameter γ.

In the present embodiment, the values of the stress generated in the overlapping portion P1 can be calculated by Equations (13) and (14) used in step S8. The equation used in step S8 may be an equation that can calculate only the value of the stress of the overlapping portion P1, or may be an equation that can calculate the value of the stress of the overlapping portion P1 and the value of the stress of the other portion.

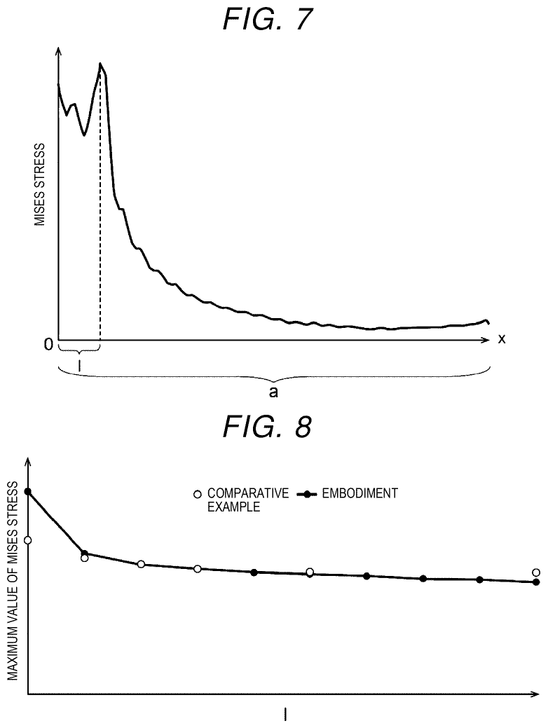

FIG. 7 is a graph showing a result of the crystal defect prediction method according to the first embodiment.

The horizontal axis of FIG. 7 represents an x-coordinate of a point on an upper surface of the device region R1 shown in FIG. 4. In FIG. 7, the point on the device region R1 satisfies the condition of 0<x<a, and the point on the overlapping portion P1 satisfies the condition of 0<x<1.

The vertical axis of FIG. 7 represents a value of the Mises stress σ_{Mises}(x, b) calculated from the above-described Equation (14). FIG. 7 shows the value of the Mises stress σ_{Mises} at each point on the upper surface of the device region R1. In FIG. 7, the values of the parameters a, b, L, l, and γ are set to a=1, b=0.5, L=1, l=0.1, and γ=0.5.

In FIG. 7, the Mises stress at 0<x<1 is greater than the Mises stress at 1<x<a. This coincides with an experimental result that a large stress is generated in the overlapping portion P1. In addition, from the calculation result shown in FIG. 7, it can be seen that the Mises stress is significantly increased near both ends of the overlapping portion P1, that is, near the points of x=0 and x=1.

In the present embodiment, the stress is calculated by using Equations (13) and (14) derived from the analytical solution of the partial differential equation of Equation (1), instead of numerically solving the partial differential equation of Equation (1). As a result, it is possible to perform a calculation of a stress and a prediction of a crystal defect at high speed.

FIG. 8 is another graph showing the result of the crystal defect prediction method according to the first embodiment.

FIG. 8 shows the calculation results of the Mises stress σ_{Mises}(x, b) of the present embodiment and a comparative example. The result of the comparative example is obtained by numerically solving the partial differential equation of Equation (1).

The horizontal axis of FIG. 8 represents a value of the parameter 1, that is, a length of the overlapping portion P1. The vertical axis of FIG. 8 represents a maximum value of the Mises stress σ_{Mises} in the overlapping portion P1. In FIG. 8, the values of the parameters a, b, and L are set to a=200, b=200, and L=400.

In FIG. 8, the result of the present embodiment is well reproduced from the result of the comparative example. Therefore, according to the present embodiment, it is possible to obtain the same calculation accuracy as that of the comparative example in a shorter calculation time than that of the comparative example.

Therefore, in the present embodiment, a stress may be calculated and a crystal defect may be predicted in a wide region in the semiconductor device of the present embodiment. According to the present embodiment, it is possible to calculate stress in a wide region and predict a crystal defect in a short time.

As described above, in the crystal defect prediction method of the present embodiment, a stress is calculated by using Equations (13) and (14) derived from the solution of the partial differential equation of Equation (1) in the step S8 of FIG. 6. Therefore, according to the present embodiment, it is possible to easily perform a calculation of a stress and a prediction of a crystal defect. For example, it is possible to accurately calculate a stress and predict a crystal defect in a short time.

### Second Embodiment

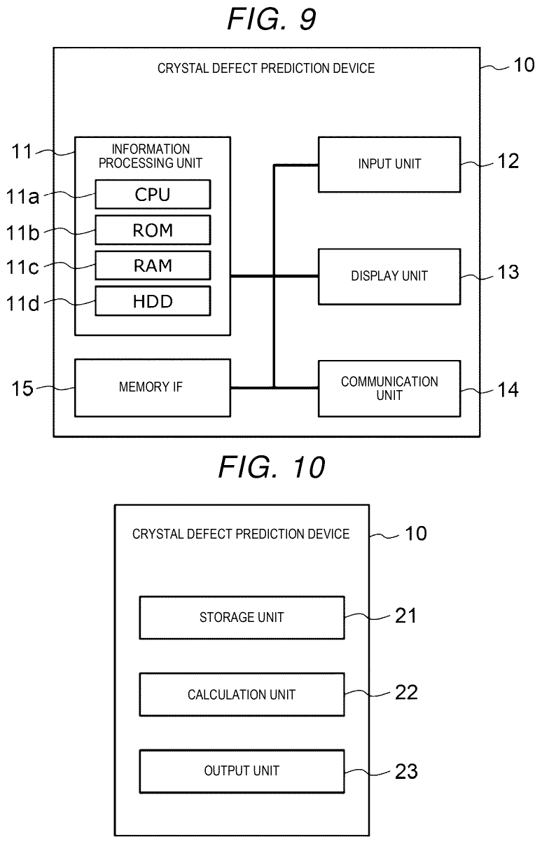

FIG. 9 is a block diagram showing a device configuration of the crystal defect prediction device 10 according to a second embodiment. The crystal defect prediction device 10 of the present embodiment performs the processing in step S8 (FIG. 6) in the crystal defect prediction method of the first embodiment.

The crystal defect prediction device 10 of the present embodiment includes an information processing unit 11, an input unit 12, a display unit 13, a communication unit 14, and a memory interface (IF) 15. The information processing unit 11 includes a central processing unit (CPU) 11a, a read only memory (ROM) 11b, a random access memory (RAM) 11c, and a hard disk drive (HDD) 11d. The crystal defect prediction device 10 according to the present embodiment is, for example, a computer such as a personal computer (PC).

The information processing unit 11 performs various types of information processing. The CPU 11a, the ROM 11b, the RAM 11c, and the HDD 11d are a processor, a non-volatile memory, a volatile memory, and a storage for the information processing, respectively.

The input unit 12 includes, for example, a keyboard, a mouse, and the like. The display unit 13 includes, for example, a liquid crystal display, an indicator, and the like. The input unit 12 and the display unit 13 are used by a user of the crystal defect prediction device 10.

The communication unit 14 includes, for example, a communication IF. The memory IF15 includes, for example, a memory slot. The communication unit 14 is used to connect the crystal defect prediction device 10 to a network by wire or wirelessly. The memory IF15 is used to insert a recording medium such as a semiconductor memory into the crystal defect prediction device 10.

In the present embodiment, a crystal defect prediction program for processing in step S8 is stored in ROM11b or HDD11d. The functional configuration shown in FIG. 10 to be described later is realized, for example, by executing a crystal defect prediction program by the CPU 11a.

When the crystal defect prediction program is installed in the crystal defect prediction device 10, a computer-readable recording medium on which the crystal defect prediction program is recorded may be prepared, and the crystal defect prediction program may be installed in the crystal defect prediction device 10 from this recording medium. Meanwhile, the crystal defect prediction program may be installed in the crystal defect prediction device by downloading the crystal defect prediction program from the network.

FIG. 10 is a block diagram showing a functional configuration of the crystal defect prediction device 10 according to the second embodiment.

The crystal defect prediction device 10 of the present embodiment includes a storage unit 21, a calculation unit 22, and an output unit 23.

The storage unit 21 stores Equations (13) and (14). Equations (13) and (14) stored in the storage unit 21 when the process in step S8 is performed may be preliminarily stored in the ROM 11b or the HDD 11d, or may be preliminarily stored in a device other than the crystal defect prediction device 10. In the former case, the storage unit 21 obtains the data of Equations (13) and (14) from the ROM 11b or the HDD 11d before the processing in step S8. In the latter case, the storage unit 21 obtains the data of Equations (13) and (14) from a device other than the crystal defect prediction device 10 via the network before the processing in step S8.

The calculation unit 22 substitutes the values of the above-described parameters a, b, L, l, and γ into Equations (13) and (14) stored by the storage unit 21. Thereby, the value of the stress generated in the overlapping portion P1 is calculated from Equations (13) and (14). For example, the values of the stress components σₓₓ(x, b), σ_{yy}(x, b), and σ_{xy}(x, b) are calculated from Equation (13), and the value of the Mises stress σ_{Mises}(x, b) is calculated from Equation (14).

The output unit 23 generates information related to a crystal defect that is predicted to occur in the semiconductor device of the first embodiment based on a value of the stress calculated by the calculation unit 22, and outputs the generated information. For example, the prediction result of a location where a crystal defect occurs is displayed on the display unit 13. The prediction result of a location where a crystal defect occurs may be output in a form stored in the HDD 11d, or may be output in a form transmitted to a device other than the crystal defect prediction device 10 via a network.

In the present embodiment, when the Mises stress σ_{Mises} at a certain point on the overlapping portion P1 is greater than a threshold, the point is determined to be a danger point at which a crystal defect is predicted to occur. The output unit 23 outputs a point at which the Mises stress σ_{Mises} is greater than a threshold as a danger point of a crystal defect. The information related to the danger point may be displayed on the display unit 13 in characters, or may be displayed on the display unit 13 in a figure or a table.

The above threshold may be a value that changes according to a value of the parameter γ. In this case, the value of the parameter γ can be adjusted to adjust the value of the threshold. For example, the calculation unit 22 may adjust the value of the threshold by adjusting the value of the parameter γ such that the prediction result of the location where a crystal defect occurs is consistent with the experimental result of the location where the crystal defect occurs. As a result, it is possible to set the threshold of the Mises stress σ_{Mises} to an appropriate value. As described above, the experimental result of the location where a crystal defect occurs can be obtained from, for example, an SEM image or a TEM image of a manufactured semiconductor device.

As described above, the crystal defect prediction device 10 according to the present embodiment calculates the stress by using Equations (13) and (14) derived from the solution of the partial differential equation of Equation (1). Therefore, according to the present embodiment, it is possible to easily perform a calculation of a stress and a prediction of a crystal defect. For example, it is possible to accurately calculate a stress and predict a crystal defect in a short time.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A crystal defect prediction method comprising:
storing, in a memory device of an information processing device, computer code that implements a formula for estimating a stress generated in an overlapping portion that is between a first layer and a second layer in a semiconductor device, the formula being derived from a differential equation that governs displacements generated in the first layer and including variables for dimensions of the first layer, dimensions of the second layer, dimensions of the overlapping portion, and a correction factor which is set based on experimental data;
setting the value of the correction factor so that a difference between the stress estimated for a sample by the formula and the stress from the experimental data generated for the sample, is within a threshold;
executing the computer code in a processor of the information processing device, after setting the value of the correction factor and after substituting actual dimensions of the first layer, actual dimensions of the second layer, and actual dimensions of the overlapping portion for the respective variables in the formula, to estimate the stress in the overlapping portion; and
determining a risk of the crystal defect in the semiconductor device based on the estimated stress in the overlapping portion.

2. The crystal defect prediction method according to claim 1, wherein the executable code is executed to estimate stresses at different locations of the overlapping region.

3. The crystal defect prediction method according to claim 2, further comprising:
identifying and outputting the location where the estimated stress is greater than a predetermined value as the location where the crystal defect occurs.

4. The crystal defect prediction method according to claim 1, wherein
the derivation of the formula includes a series expansion.

5. The crystal defect prediction method according to claim 4, wherein
the derivation of the formula includes solving the differential equation assuming that a solution to the differential equation is represented by the series expansion that is of a variable separation type.

6. The crystal defect prediction method according to claim 1, wherein
the derivation of the formula includes solving the differential equation using a potential function of the stress.

7. The crystal defect prediction method according to claim 6, wherein
the potential function is an Airy stress function.

8. The crystal defect prediction method according to claim 1, wherein
the derivation of the formula includes solving the differential equation using a boundary condition related to the stress.

9. The crystal defect prediction method according to claim 8, wherein
the boundary condition is represented by a function that localizes a pressure to the overlapping portion that the first layer receives from the second layer.

10. The crystal defect prediction method according to claim 8, wherein
the boundary condition is represented by a function in which a pressure to the overlapping portion received by the first layer from the second layer is a value other than 0 in the overlapping portion and 0 outside the overlapping portion.

11. The crystal defect prediction method according to claim 8, wherein
the formula includes a parameter that represents the boundary condition.

12. The crystal defect prediction method according to claim 1, wherein
the derivation of the formula includes solving the differential equation using an even extension of a region of the first layer.

13. The crystal defect prediction method according to claim 1, wherein
the differential equation is a partial differential equation that assumes the first layer to be in a state of planar distortion.

14. The crystal defect prediction method according to claim 1, wherein
the first layer is a substrate in the semiconductor device, and the second layer is a gate conductive film in the semiconductor device.

15. The crystal defect prediction method according to claim 14, wherein
the dimensions of the first layer are dimensions of a device region in the substrate.

16. The crystal defect prediction method according to claim 1, wherein
the dimensions of the first layer, the dimensions of the second layer, and the dimensions of the overlapping portion are respectively dimensions of the first layer, dimensions of the second layer, and dimensions of the overlapping portion in a vertical cross-section of the semiconductor device.

17. The crystal defect prediction method according to claim 1, wherein
the dimensions of the first layer include a length of a first side and a length of a second side of a rectangle representing a shape of the first layer in the vertical cross-section of the semiconductor device,
the dimensions of the second layer include a length of a third side of a rectangle representing a shape of the second layer in the vertical cross-section of the semiconductor device, and
the dimensions of the overlapping portion include a length of the overlapping portion in the vertical cross-section of the semiconductor device.

18. The crystal defect prediction method according to claim 1, wherein
the estimated stress has a value that corresponds to a value of at least one component among a plurality of components of a tensor representing the stress, or is a Mises stress obtained from the tensor.

19. A crystal defect prediction program causing a computer to execute a crystal defect prediction method, the method including:
storing, in a memory device of the computer, computer code that implements a formula for estimating a stress generated in an overlapping portion that is between a first layer and a second layer in a semiconductor device, the formula being derived from a differential equation that governs displacements generated in the first layer and including variables for dimensions of the first layer, dimensions of the second layer, dimensions of the overlapping portion, and a correction factor which is set based on experimental data;
setting the value of the correction factor so that a difference between the stress estimated for a sample by the formula and the stress from the experimental data generated for the sample, is within a threshold;
executing the computer code in a processor of the computer, after setting the value of the correction factor and after substituting actual dimensions of the first layer, actual dimensions of the second layer, and actual dimensions of the overlapping portion for the respective variables in the formula, to estimate the stress in the overlapping portion; and
determining a risk of the crystal defect in the semiconductor device based on the estimated stress in the overlapping portion.

20. A crystal defect prediction device comprising:
a memory device storing first computer code that implements a formula for estimating a stress generated in an overlapping portion that is between a first layer and a second layer in a semiconductor device, the formula being derived from a differential equation that governs displacements generated in the first layer and including variables for dimensions of the first layer, dimensions of the second layer, dimensions of the overlapping portion, and a correction factor which is set based on experimental data;
a processor that executes second computer code to:
set the value of the correction factor so that a difference between the stress estimated for a sample by the formula and the stress from the experimental data generated for the sample, is within a threshold;
execute the first computer code after setting the value of the correction factor and after substituting actual dimensions of the first layer, actual dimensions of the second layer, and actual dimensions of the overlapping portion for the respective variables in the formula, to estimate the stress in the overlapping portion; and
determine a risk of the crystal defect in the semiconductor device based on the estimated stress in the overlapping portion.
